(19) United States
(12) Patent Application Publication
(10) Pub. No.: US 2010/0191378 A1
(43) Pub. Date: Jul. 29, 2010

(54) DISTRIBUTED POWER TOWERS WITH DIFFERENTIATED FUNCTIONALITIES

(75) Inventors: Yoel Gilon, Jerusalem (IL); Israel Kroizer, Jerusalem (IL); Gabriel Kaufmann, Beit Hananya (IL)

Correspondence Address: MILES & STOCKBRIDGE PC, 1751 PINNACLE DRIVE, SUITE 500, MCLEAN, VA, 22102-3833, US

(73) Assignee: BRIGHTSOURCE INDUSTRIES (ISRAEL) LTD., Jerusalem, IL (US)

(21) Appl. No.: 12/532,942

(22) PCT Filed: Mar. 26, 2008
(86) PCT No.: PCT/US2008/058305

§ 371 Date: Apr. 2, 2010

Related U.S. Application Data
(60) Provisional application No. 60/896,991, filed on Mar. 26, 2007.

(51) Int. Cl. G05B 15/00; F24J 2/38; F24J 2/40; F03G 6/06

(52) U.S. Cl. 700/275; 126/578; 126/601; 60/641.15

(57) ABSTRACT

A concentrating solar system has multiple receivers, in some embodiments mounted on multiple towers, on which solar energy is concentrating using heliostats. At least some heliostats are controlled such that they may direct energy onto different receivers to achieve any of various control goals, such as temperature or flux uniformity of the receiver. In preferred embodiments, the receivers or receiver portions are fluidly connected in stages such that there are high temperature targets, e.g., superheated receivers or portions, and low temperature targets, e.g. evaporating receivers or targets. By doing so, it is possible to selectively control heliostats to track for directing energy on the targets to, for example, achieve temperature uniformity of the high temperature target by selecting heliostats for that control goal under varying circumstances.

### CROSS-REFERENCE TO RELATED APPLICATIONS

The present application claims the benefit of U.S. Provisional Patent Application No. 60/896,991, entitled “Distributed Power Towers with Differentiated Functionalities”, filed Mar. 26, 2007, which is hereby incorporated by reference in its entirety.

### FIELD OF THE INVENTION

The present invention is directed to a solar collector system and more specifically to solar field modules which concentrate sunlight onto a solar receptor by the use of dynamically configurable heliostatic mirrors.

### SUMMARY OF THE INVENTION

Briefly, a concentrating solar system has multiple receivers, in some embodiments mounted on multiple towers, on which solar energy is concentrating using heliostats. At least some heliostats are controlled such that they may direct energy onto different receivers to achieve any of various control goals, such as temperature or flux uniformity of the receiver. In preferred embodiments, the receivers or receiver portions are fluidly connected in stages such that there are high temperature targets, e.g., superheated receivers or portions, and low temperature targets, e.g. evaporating receivers or targets. By doing so, it is possible to selectively control heliostats to track for directing energy en the targets to, for example, achieve temperature uniformity of the high temperature target by selecting heliostats for that control goal under varying circumstances.

An embodiment of a solar power system may include at least one central receiver with at least two receiver portions defining at least two respective targets. Heliostats may be arranged in a two-dimensional pattern and configurable such that each can track the apparent diurnal and trans-seasonal movement of the sun to direct sunlight onto an assigned one of the targets. The targets may be located at different locations. At least some of the heliostats may be configured to move in two dimensions to direct sun onto a first assigned one of the targets and on a second assigned one of the targets. A controller may be configured to select a heliostat and change its assigned target responsively to real time insolation data.

Insolation level sensors may be arranged to detect respective levels of light captured by respective ones of the heliostats. The insolation level sensors may output real time insolation data.

Further, the at least one central receiver may include at least two receivers. A first receiver of the at least two receivers may have a first operating temperature higher than a second operating temperature of a second of the at least two receivers. The first and second receivers may have respective surfaces to which solar energy is incident. The controller may be configured to assign heliostats to achieve uniform temperature over the first receiver surface at the expense of uniformity of temperature over the second receiver surface.

An embodiment of a method of controlling a central solar concentrating energy system may include, at a first time, determining the amount of energy directable by each of a plurality of heliostats onto each of at least two targets located at different positions. The targets may include heat exchangers configured to heat a working fluid and power a generator. At a first time, each of the plurality of heliostats may be aimed on a first respective one of the at least two targets responsive to the results of the determining. The determining may then be repeated a second time. At the second time, at least one of the plurality of heliostats aimed in the first aiming may be aimed on a second, different respective on of the at least two targets.

The determining may include measuring respective rates of insolation on each of the plurality of heliostats or groups thereof. The at least two targets may be located in separate towers.

Additionally, the first respective one of the at least two targets may have a higher operating temperature than the second respective one of the at least two targets. The method may also include determining a uniformity of temperature or energy flux on the first receiver wherein the second aiming is responsive to the determining a uniformity. The method may also include measuring a uniformity of temperature or energy flux on the first receiver wherein the second aiming is responsive to the measuring a uniformity.

An embodiment of a solar energy collection system may include one or more first towers and one or more second towers. Each first tower may support a first receiver, and each second tower may support a second receiver. Each second receiver may be configured to generate steam using energy from radiation incident thereon. Each first receiver may receive the generated steam from one or more second receivers and may superheat the steam using energy from radiation incident thereon. The system may also include a plurality of heliostat-mounted mirrors. Each second tower may be assigned a respective subset of the plurality of heliostat-mounted mirrors. Each heliostat-mounted mirror in the respective subset may direct incident solar radiation onto the second receiver in the assigned second tower. The system may also include a controller configured to control the plurality of heliostat-mounted mirrors. The controller may be capable of changing the assignment of heliostat-mounted mirrors in each said subset so as to redirect incident solar radiation onto the first receiver of the one or more first towers so as to maintain a predetermined state of the first receiver.

The predetermined state may include a ratio of incident solar radiation directed onto the first receiver in the one or more first towers to incident solar radiation directed onto the second receiver in the one or more second towers. The predetermined state may include a uniform temperature on surfaces of each first receiver. The predetermined state may include a uniform heat flux on surfaces of each first receiver. The predetermined state may include a temperature profile on surfaces of each first receiver. The predetermined state may include a heat flux profile on surfaces of each first receiver.

Further, each first receiver may operate at a higher temperature than each second receiver. A turbine electric power plant may be configured to use the superheated steam from the first receiver of the one or more first towers. One or more first towers may be arranged closer to the turbine electric power plant than the one or more second towers. Each first tower may be arranged closer to the turbine than each second tower.

In addition, each first tower may be assigned a different respective subset of the plurality of heliostat-mounted mirrors. Each heliostat in the different respective subset may direct incident solar radiation onto the first receiver in the assigned first tower. The controller may be capable of changing the configuration of each said different subset to direct incident solar radiation onto or away from the respective first receiver. The controller may be configured to change the configuration of the subset of heliostats in real-time.

The solar collection system may include a monitoring system configured to monitor the state of the first receiver in the one or more first towers. The controller may use the information from the monitoring system to determine changes in the configuration of each said subset. The monitoring system may include a device employing infrared videography or infrared photometry. The monitoring system may also provide information on incident solar radiation on each of the plurality of heliostats. The monitoring system may provide information on environmental conditions.

An embodiment of a method may be used for controlling heliostat-mounted mirrors in a solar energy collection system. The solar energy collection system may include a first receiver, a second receiver, and a plurality of heliostat-mounted reflectors. The first receiver may have more stringent operating criteria or requirements than the second receiver. Each heliostat-mounted reflector may be assigned to one of the first receiver or the second receiver such that the heliostat-mounted reflector may direct incident solar radiation onto the assigned first or second receiver. The method may include observing a state of the first receiver. The observed state may be compared to a predetermined state for the first receiver. The predetermined state may be related to the operating criteria or requirements for the first receiver. The method may include changing the assignment of at least a portion of the plurality of heliostat-mounted mirrors based on the comparison.

Further, the predetermined state may include a predetermined temperature profile of a surface of the first receiver. The predetermined temperature profile may be a uniform temperature. The predetermined state may also include a predetermined heat flux profile on a surface of the first receiver. The predetermined heat flux profile may be a uniform heat flux. The predetermined state may be temperature or condition dependent. The predetermined state may change depending on environmental or operating conditions. In addition, the first receiver may operate at a higher temperature than the second receiver.

Objects, advantages and features of the present invention will become apparent from the following detailed description of the invention when considered in conjunction with the accompanying drawings.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention. Throughout the figures, like reference numerals denote like elements.

FIGS. 1A and 1B are diagrammatic views of systems of distributed power towers and associated fields of heliostats.

FIG. 2 is a diagrammatic view of a system of distributed power towers and associated fields of heliostats.

FIG. 3 is a diagrammatic view of a system of distributed power towers and associated fields of heliostats.

FIG. 4 is a diagrammatic plan view of a solar receiver.

FIG. 5 is a diagrammatic view of a system of distributed power towers and associated fields of heliostats.

FIG. 6 is a diagrammatic elevation view of a solar receiver.

FIG. 7A is a diagrammatic view of a system of distributed solar power towers and associated fields of heliostats.

FIG. 7B is an illustration of a photometric insolation-distribution sensing arrangement.

FIG. 8 is a simplified process flow diagram of an exemplary embodiment of a process used.

### DETAILED DESCRIPTION

A solar energy-based power generation system may convert solar energy to thermal energy and use the thermal energy to drive a generator. In the illustrative embodiments described herein, steam is employed as a working fluid to power a prime mover, preferably a turbine operating on a Rankine cycle. The prime mover, which may be accompanied by additional prime movers in a single system, may be used for electric power generation, pumping, or any other suitable purpose. Preferably, the prime mover or movers is/are connected directly to a generator for electric power generation. One or more solar receivers are employed to receive concentrated sunlight from heliostats and convert the sunlight to heat. In some embodiments, the working fluid, such as water/steam, is circulated through the receiver. In other embodiments, a heat transfer fluid is circulated which transfers heat to the working fluid via an intermediate heat exchanger.

In a system embodiment, a plurality of distributed solar power towers, each of which is nominally associated with a plurality of heliostat-mounted mirrors capable of reflecting solar radiation onto a central solar receiver situated substantially atop each tower. Each central solar receiver uses reflected and optionally concentrated solar radiation for preheating water, and/or evaporating water, and/or superheating steam, and contains conduits, pipelines, or the like, for providing ingress and egress to water or steam. Optimally, superheated steam is directed to a single steam turbine electric power plant for the production of electricity.

Preferably each tower is fixedly positioned within the borders of a field containing the heliostats with which the tower and its solar receiver are nominally associated and upon which heliostats are mounted the mirrors with which the tower and its solar receiver are also nominally associated.

Preferably, at least one heliostat-mounted mirror may be directed to reflect solar radiation alternately onto the solar receiver to which is normally assigned and at least one other receiver. Each so-directable mirror has a range of movement or is otherwise mechanically movable such that it can direct sunlight on more than one receiver. That is, each heliostat swivels, rotates, turns or pivots to track the movement of the sun across the sky in a first mode such that it directs sunlight onto a specified receiver, but can also be commanded to a second mode in which it tracks the sun such that it reflects sunlight toward a different receiver. The transfer from first mode to the second mode may be identified as “switching” from one receiver to another. Some heliostats may be switchable between two receivers, some not at all, and some may be switchable among more than two receivers.

The heliostat may be assigned to track sunlight onto a second tower, or to the tower to which it is normally assigned, or to any other tower. The normal assignment may be provided in a normal assignment table in one or more digital controls. The schedule may contain predefined assignments of heliostats to receivers according to time of day and/or time of year. Thus, on a typical cloudless day in which all heliostats are operative, for a given time of day and a given time of year, each heliostat would be assigned to track the sun such that the light it captures is reflected onto a particular assigned receiver. The location of the heliostat relative to the receiver may not necessarily indicate the receiver to which it is assigned since interleaving rows of heliostats in adjacent fields produces certain real estate utilization advantages.

Also, preferably, each switchable heliostat is equipped to receive electronically or mechanically transmitted instructions to switch receivers, the instructions being transmitted over wires or fiber optic cables, or wirelessly, or, alternately, through physical action or adjustment made by an operator who is physically present from time to time at each heliostat.

Also, preferably, a control system is provided for transmitting direction-fixing or direction-changing instructions to at least one heliostat, causing the at least one heliostat to switch reflective focus from one solar receiver to another, including from the tower with to the heliostats are normally assigned to a second tower, or back to the tower to which the heliostats are normally assigned from a second tower, or from one tower to another when neither of them is the tower to which the heliostats are normally assigned. In yet another particularly preferred embodiment, the control system transmits simultaneous direction-fixing or direction-changing instructions to a plurality of heliostats in one or more of the heliostat fields. In accordance with a further particularly preferred embodiment, the control system transmits simultaneous direction-fixing or direction-changing instructions to all heliostats in all of the heliostat fields.

The transmitted instructions may include, but not exhaustively, information regarding when a switch is to be made, for how long each heliostat is to remain switched, and to where each switched heliostat will be switched next. Heliostat or heliostat-mounted control systems may be equipped to store such instructions for later execution and/or data retrieval.

The control system may provide instructions based on previously programmed field configurations, on ad-hoc or single-use configurations, or on up-to-the-minute calculations of field and system parameters that may include, but not exhaustively, instantaneous and cumulative solar flux, other climatic conditions and measurements, receiver inlet and outlet temperatures and pressures, receiver heat flux measurements, time of day, day of the year, differential electricity tariff's, regulatory fossil fuel allowances and restrictions, power purchase agreements with electric companies, revenue targets, and maintenance requirements, where the calculations are dynamically performed by an operator with or without the aid of a computerized performance model or alternatively by a computerized performance model without the intervention of an operator.

In another embodiment, for every n+1 towers, one tower is dedicated to the superheating of steam substantially generated in the other n towers in that the solar receiver atop that tower is configured only for superheating steam. Optimally, a steam turbine electric power plant, if provided, is located in close proximity to the n+1th tower in order to minimize the extent and distance to which superheated steam is transported. In one aspect of the preferred embodiment, solar radiation is reflected upon the external surface of the receiver of the n+1th tower with a flux of 100 to 250 kilowatt (kW) per square meter (sqm) of receiver surface area.

Preferably, steam at a pressure in the range 140 to 180 bar is superheated in the solar receiver of the n+1th tower to a temperature in the range 520 to 560 deg C. In a particularly preferred embodiment, steam at a pressure of substantially 160 bar is superheated to 540 deg C. In another particularly preferred embodiment, steam is superheated at an inlet pressure and to the inlet temperature of a provided steam turbine electric power plant as specified by the manufacturer of the turbine.

Preferably, the system has a separate superheating receiver that is larger than the receivers of each multiple other towers in terms of both volume and external surface area. In one especially preferred embodiment, the superheating receiver is at least 20 percent larger by volume and external surface area, and in another especially preferred embodiment the receiver is between 20 and 40 percent larger.

In another embodiment, some solar receivers perform preheating of water and steam generation, but substantially no superheating. In each of these receivers, water is heated under pressure to 280 to 360 deg C. and evaporated to steam. The water may be heated under pressure to approximately 320 deg C. Solar radiation may be reflected onto each of the non-superheating receiver or receivers to achieve a flux of about 100 to 600 kW/sqm. The superheating receiver receives 35 to 45 percent of the total solar energy reflected by the heliostat-mounted mirrors.

In a variation, superheating is used to achieve temperatures of 440 to 490 deg C. As an example, solar radiation may be reflected on the non-superheating receivers with a flux of 250 to 750 kW/sqm. In an example, a superheating receiver or receivers, receives 25 to 35 percent of the total solar energy reflected by the all the heliostat-mounted mirrors.

Preferably, the directing of heliostats to reflect solar radiation onto the receivers of the various n+1 towers is controlled to achieve a specified goal state including distribution of solar heat flux, superheating receiver temperature, steam temperature and steam pressure. Although the embodiments described herein relate to pressures in which water phase change occurs, higher temperatures may be used and in such case, there may be one or more high temperature receivers of a supercritical flow. The goal states for management of such a supercritical receiver would be similar as those discussed for a superheater.

In an embodiment, heliostats are controlled to reflect solar radiation onto the external surface of the receiver of the n+1th tower with flux over a north-facing section of the to achieve about 230 kW/sqm flux; over a south-facing section of the receiver to achieve about 70 to 100 kW/sqm, and flux over an east-facing and a west-facing sections of the receiver of about 120 to 180 kW/sqm. The north-facing section and the south-facing section each may comprise substantially one-third of the receiver circumference and the east-facing and west-facing sections each comprise substantially one-sixth of the receiver circumference.

Preferably, for every n+1 towers, one tower is dedicated to the superheating of steam substantially generated in the other n towers. Also, n fields are provided which are nominally associated with the other n towers, and there is no n+1th field nominally associated with the n+1th tower. The directing of heliostats in the various n fields to reflect solar radiation onto the receivers of the various n+1 towers is performed so as to optimize the superheating performance of the receiver of the n+1th tower in terms of criteria that include, but not exhaustively, distribution of solar heat flux, steam temperature and steam pressure.

In another embodiment, for every n+1 towers, one tower is dedicated both to the superheating of steam substantially generated in the other n towers and to the reheating of steam transported thereto from an outlet of a steam turbine with a reheat cycle in that the solar receiver atop that tower is configured only for superheating and reheating steam. Optimally, a steam turbine electric power plant is provided in close proximity to the n+1th tower in order to minimize the extent and distance to which steam is transported. In one aspect of the preferred embodiment, solar radiation is reflected upon the external surface of the receiver of the n+1th tower with a flux of 100 to 250 kilowatt (kW) per square meter (sqm) of receiver surface area.

Preferably, in the foregoing embodiment, steam largely generated in the receivers of the other n towers at a pressure in the range 120 to 200 bar is superheated in the solar receiver of the n+1th tower to a temperature in the range 520 to 560 deg C., and steam transported from an outlet of a steam turbine with at least a single reheat cycle at a pressure of 20 to 40 bar is reheated to a temperature in the range 460 to 500 deg C. In a particularly preferred embodiment, steam at a pressure of substantially 170 bar is superheated to 540 deg C. and steam in the reheat cycle at a pressure of 32 bar is superheated to 485 deg C.

In any of the embodiments, steam may be superheated at a recommended inlet pressure and to the recommended inlet temperature of a provided steam turbine with at least a single reheat cycle as specified by the manufacturer of the turbine, and steam may be reheated at a recommended pressure and to the recommended temperature of the reheat cycle of the turbine as specified by its manufacturer.

In another embodiment of the invention, the solar receivers at the other n towers perform preheating of water and steam generation, but substantially no superheating. In each of these receivers, water is heated under pressure to 280 to 400 deg C. and evaporated to steam. According to a preferred aspect of this embodiment, the water is heated under pressure to substantially 360 deg C.

According to another aspect of this embodiment, solar radiation is reflected on each of the n non-superheating receivers with a flux of 100 to 600 kW/sqm. In yet another aspect of the embodiment, the receiver of the n+1th tower, which is dedicated to superheating and reheating, receives 35 to 45 percent of the total solar energy reflected by the heliostat-mounted mirrors of the n+1 fields.

In yet another embodiment of the invention, the solar receivers at the other n towers perform preheating of water and steam generation, and partial superheating, whereby water is heated under pressure to 280 to 400 deg C., and evaporated to steam and the steam is then further heated to 440 to 490 deg C. According to a preferred aspect of this embodiment, the water is heated under pressure to substantially 360 deg C. and the steam is superheated to substantially 470 deg C. According to another aspect of this embodiment, solar radiation is reflected on each of the n non-superheating receivers with a flux of 100 to 600 kW/sqm. In yet another aspect of the embodiment, the receiver of the n+1th tower, which is dedicated to superheating and reheating, receives 30 to 40 percent of the total solar energy reflected by the heliostat-mounted mirrors of the n+1 fields.

In a further embodiment of the invention, steam in the reheat cycle is at a pressure lower than the pressure of the steam largely generated by the receivers of the other n towers and is transported to the receiver of the n+1th tower at a temperature lower than that of the steam largely generated by the receivers of the other n towers. In a preferred aspect of the present embodiment, steam in the reheat cycle is transported to the receiver of the n+1th tower at a pressure of 20 to 40 bar and in a particularly preferred aspect at a temperature in the range 300 to 340 deg C. According to yet another embodiment, steam in the reheat cycle is transported to the receiver from an outlet at the high pressure stage of the steam turbine.

According to a further embodiment, steam in the reheat cycle is transported to the receiver from an outlet at the intermediate pressure stage of the steam turbine.

Preferably, the reheating section of the receiver of the n+1th tower includes specific conduits, pipes or tubes, or groups of conduits, pipes or tubes, and the superheating section includes other specific conduits, pipes or tubes, or groups of conduits, pipes or tubes, where at least some of the reheating conduits, pipes or tubes, or groups thereof, may be interposed among at least some of the superheating conduits, pipes or tubes, or groups thereof. In yet another preferred embodiment the reheating conduits, pipes or tubes are physically separated from the superheating conduits, pipes or tubes. In yet a further preferred embodiment all of the reheating conduits, pipes or tubes may be in a lower section of the receiver and all of the superheating conduits, pipes or tubes may be in a higher section. In one aspect of this embodiment the reheating conduits, pipes or tubes are in a separate boiler within the same receiver and in another aspect they are in a separate receiver, where the separate boiler or receiver dedicated to reheating is lower than the separate boiler or receiver dedicated to superheating and optimally receives 30 to 45 percent of the total solar energy reflected by the heliostat-mounted mirrors of the n+1 fields onto the receiver or receivers of the n+1th tower.

In accordance with another embodiment of the invention there is provided a solar receiver both for superheating steam optionally transported thereto from another solar receiver or other boiler and for reheating steam transported thereto from an outlet of a steam turbine with a reheat cycle.

In a preferred embodiment the solar receiver comprises two boilers or boiler sections where one boiler or boiler section is provided for superheating steam and other is for reheating steam. In one aspect of the embodiment the superheating boiler or boiler section superheats steam previously pressurized to more than 100 bar to substantially 560 deg C. from 470 deg C. and in another aspect to substantially 560 deg C. from 360 deg C. In a preferred aspect the steam is previously pressurized to 180 bar. In yet another aspect the reheating boiler or boiler section reheats steam previously pressurized to more than 10 bar to substantially 485 deg C. from a temperature in the range 320 to 340 deg C., and in another preferred aspect the steam in the reheat cycle is at 32 bar. In a particularly preferred embodiment the reheating boiler or boiler section is at a lower height than the superheating boiler or boiler section.

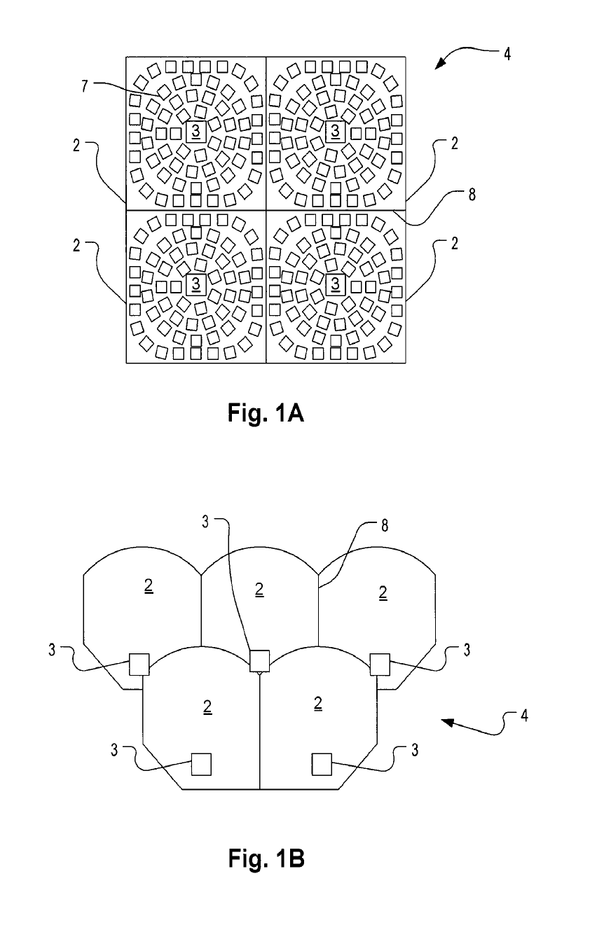

Referring now to the FIG. 1A, which is a plan view, a system 4 has a plurality of solar fields 2 each having a tower 3 with a receiver (not shown separately) standing therein. The heliostat field 2 is illustrated for simplicity here as a contiguous square area filled with heliostats 7. All of the heliostats 7 in a field are nominally associated with the tower 3 standing at the center of the field 2. The nominal association may be made dependent on the time of year and time of day. The nominal association may be stored in memory connected to a controller (not shown in the present figure by discussed and illustrated elsewhere) which determines the tracking behavior of each heliostat 7.

Although the areas of heliostats 7 that are nominally associated with a tower are shown as contiguous areas 2 in this example, this is for simplicity of illustration and in a real system, there would be expected to be overlap such that heliostats 7 assigned to one tower 3 are interleaved with heliostats assigned to another tower. This has been found to be optimal to make land use more efficient where adjacent heliostats can shade each other and is therefore preferred. However, for purposes of discussion and simplified illustration, heliostats 7 that are commonly assigned are shown as covering a contiguous area 2.

Although the fields illustrated in FIG. 1A are four in number, the actual number of fields may vary. Similarly, the heliostat fields in this figure are shown as substantially square, but this is only for purposes of illustration and heliostat fields can be laid out in any suitable geometric shape, including circular, crescent, fishscale-shaped (as illustrated in FIG. 1B where reference numeral are used to identify the same items), oval, or any suitable. The fields may be filled with heliostats 7 up to the boundaries 8 between fields or not. Also, the towers 3 need not be at the center of the associated fields 2 as illustrated in FIG. 1B. Towers 3 may be located anywhere within the confines of their associated field 2 or even outside the associated field 2 but preferably are located at a point that is determined to optimize solar energy capture, electricity production, revenue generation from sales of electricity, or any desired optimization parameter.

Preferably, the heliostats 7 associated with a particular tower 3 include a plurality of heliostat-mounted mirrors (not shown) which reflect solar radiation substantially onto the central receiver (also not shown) situated at or near the top of the tower to minimize shading of heliostats by adjacent heliostats. Note however that in northern latitudes with heliostat fields arrayed on a slope, the receivers may be located close to the ground or even at ground level. Heliostats preferably track in response to the apparent movement of the sun across the sky on each day and similarly compensate for the elevation of the sun as the seasons change. Preferably, this function is provided by a control system which may be distributed with a controller for each heliostat or for a subset of the heliostats, or with a central controller of the receiver unless directed otherwise by a control system if, for example, it is determined that instant insolation is causing the receiver to exceed some predetermined threshold of heat flux.

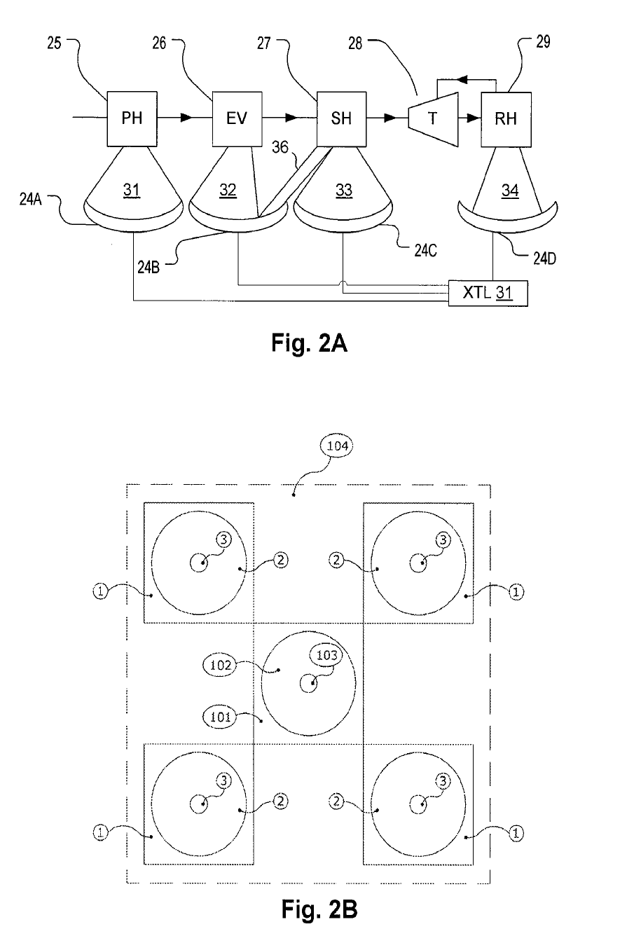

Referring now to FIG. 2A, a system includes a preheating stage, an evaporation stage, a superheating stage, and a reheating stage. A receiver, a portion of a receiver, or multiple receivers or portions are represented by the box indicated at 25. For simplicity this will be referred to as receiver 25. Receiver 25 is configured such that a selected quantity of light 31 from a heliostat array 24A is incident thereon. A controller 31 controls each of the heliostats (not shown individually in this figure) in the arrays 24A-24D. The array 24A includes a selected set of heliostats and does not necessarily represent a contiguous array. The array 24A is preferably a subset of a larger set of heliostats which includes those of arrays 24B, 24C, and 24D. The light 31 heats the receiver 25 which in turn preheats water, either directly or via a combination of a circulating heat transfer fluid and a heat exchanger which are not shown. Preheated water is then evaporated in an evaporating stage by the heat collected by a receiver 26 (which also may be one or more receivers or receiver portions). The light 32 from heliostat array 24B is incident on the evaporator receiver 26 and provides the energy for evaporation. Similarly light 33 from heliostat array 24C is incident on the superheating receiver 27 and provides the energy for superheating steam. Superheated steam drives a turbine 28. A reheat section 29, 24D may be provided as well.

Preferably, at least some of the receivers 25-27 and 29 are configured such that they can be selectively illuminated by selected heliostats of respective arrays in the manner discussed above. That is, selected heliostats assigned to one receiver can be diverted to another receiver to achieve any of several objectives. This diversion of heliostats from one receiver 26 to another receiver 27, is illustrated in FIG. 2A by the flux indicated figuratively at 36. Note that the embodiment of FIG. 2A may be modified to include more or fewer stages and the stages may be different, such as for example with a Brayton cycle-based system using air. In the latter case, the stages may be temperature stages. The separation of the temperature stages allows the controller 31 to select heliostats to achieve and maintain temperature or flux uniformity goal state as conditions change by selecting heliostats and aiming points appropriately.

According to various embodiments, the diversion of heliostats from one receiver to another is used to rebalance the ratio of evaporation and superheating to achieve a desired operation goal. For example, where the net insolation rate of the entire system is compensated by sliding pressure the ratio of energy used for steam production and superheating is desirably changed. For another example, when the ability of certain heliostats to supply reflected light to a particular receiver is compromised, such as by transient cloud coverage, damage, or becoming faulty, heliostats can be reallocated to achieve specified control goals, such as temperature uniformity of a high temperature receiver. Any of the arrays 24A through 24D may be configured to be divertible in such a manner to achieve various objectives.

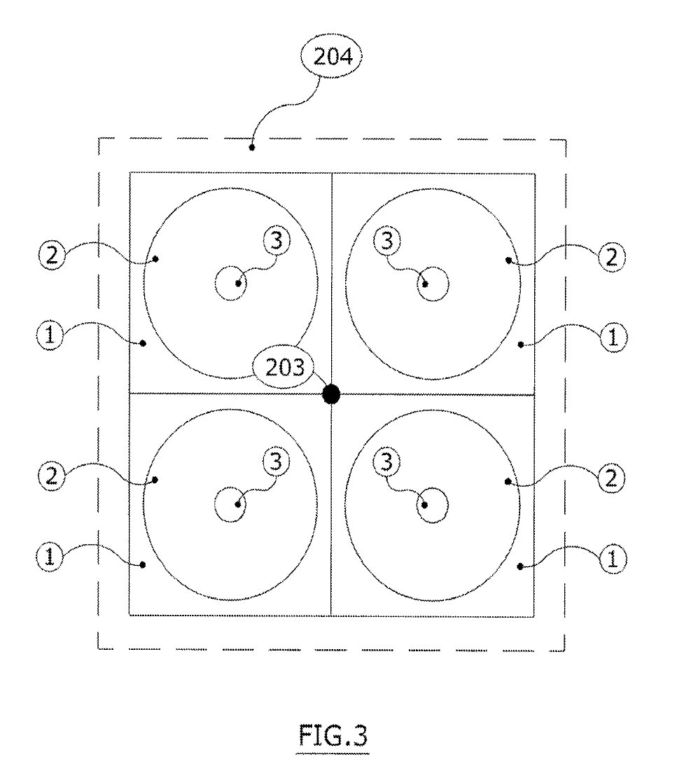

In an embodiment of FIG. 2A, illustrated in FIG. 2B, n receivers are dedicated to steam generation and one receiver is dedicated to superheating of steam generated by the other n receivers. In an embodiment, the steam generating receivers are provided atop one or more respective towers and the superheating receiver is provided on a separate tower or a separate part of a tower shared by any combination of steam generating, superheating or reheating receivers. For example as shown in FIG. 2B, n towers are provided with steam generating receivers, which are also boilers. One tower carries a superheating receiver which receives steam from the boilers. System 104 has n+1 solar fields 1 and 101 and n+1 solar power towers (towers with receivers on them) 3 and 103. For example, in FIG. 3B, n is equal to four. The system is laid out so that in each of n solar fields 1 a tower 3 is associated with a heliostat field 2 such that each tower 3 stands near or within the heliostat field 2 with which it is associated, and in an n+1th solar field 101, an n+1th central solar power tower 103 is associated with a heliostat field 102 such that the n+1th tower 103 is near or within the boundaries of the heliostat field with which it is associated. Although for purposes of illustration the system has been illustrated with the n+1th field 101 substantially in the center of system 104, the n+1th field 101 and the n+1th tower may be placed anywhere in system 104.

In a variation, towers are provided where, for every n+1 towers one tower is dedicated to the superheating of steam substantially generated in the other n towers, n fields are provided which are nominally associated with the other n towers, and there is no n+1th field nominally associated with the n+1th tower. In this system, illustrated by example in FIG. 3, a system 204 having n solar fields 1, n solar power towers 3 each fixedly positioned therein, and an n+1th tower 203, is shown. In this example, n is equal to four. The system is laid out so that in each of n solar fields 1 a tower 3 is associated with a heliostat field 2 such that each tower 3 is near or within the boundaries of the heliostat field 2 with which it is associated. An n+1th central solar power tower 203 is not associated with any heliostat field. The heliostats are controlled to reflect solar radiation onto the receivers of the various n+1 towers 3 and 203 so as to provide a balance between steam generation and superheating to optimize the performance. Thus, the system employs heliostats in the n fields 2 accordingly to heat the receiver of the n+1th tower 203.

In an embodiment, the heliostats of the fields are controlled to direct light onto the receivers so as to provide a goal temperature profile (or goal flux profile) on the superheating receiver or a high temperature receiver where a heat transfer fluid used. In the high temperature receiver or receivers, because of high pressures and temperatures (magnitudes discussed elsewhere), the highest operating temperatures may be achieved within channels of materials of limited mechanical tolerance when there is a specified degree of temperature uniformity. The degree of uniformity of temperature/flux or the desired temperature or flux profile will vary based on the design, but in order ensure against hot spots where failures may occur or non-uniform temperatures which may create thermal stresses due to differential expansion, a goal temperature profile or uniformity level may be defined. By controlling the heliostats such that at least selected heliostats can be aimed at selected receivers, the ability of a system to achieve the goal state with high utilization efficiency of the heliostats and real estate can be achieved.

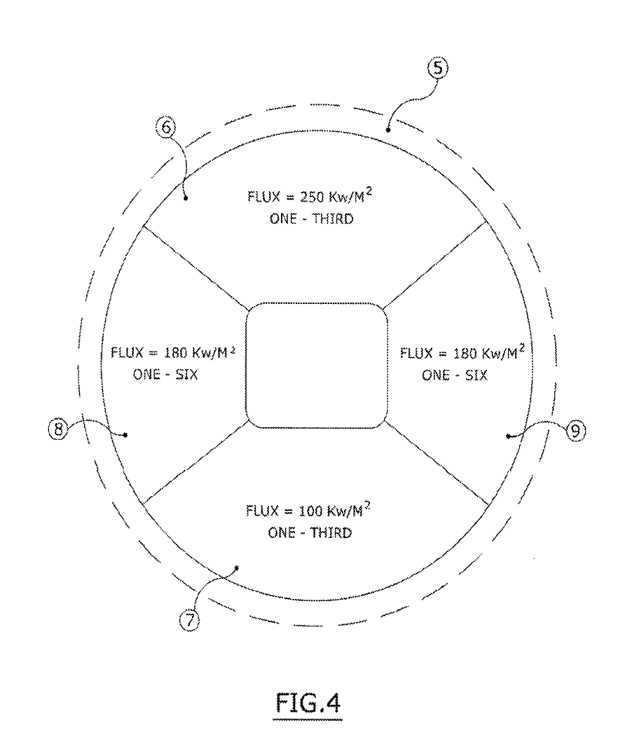

FIG. 4 illustrates a cross-section of a solar receiver 5 of an n+1th tower (not shown) where the principal criterion for optimization is that solar radiation is to be reflected onto the external surface of the receiver 5 with flux over a north-facing section 6 of the receiver being substantially equal to 250 kW/sqm, flux over a south-facing section 7 of the receiver being substantially equal to 100 kW/sqm, and flux over an east-facing and a west-facing section 9 and 8, respectively, of the receiver being substantially equal to 180 kW/sqm. The north-facing section 6 and the south-facing section 7 each comprise substantially one-third of the receiver circumference and the east-facing and west-facing sections 9 and 8, respectively, each comprise substantially one-sixth of the receiver circumference. The above criterion may be modified based on geographic location. For example, the above-criterion may be altered for a geographic location in the southern hemisphere versus a location in the northern hemisphere.

Temperature and/or flux may be measured in real time and corrected to achieve a desired profile. For example, using infrared video or optical video to see radiation emanating from the receiver may be used to judge such parameters. Also temperature sensors such as thermocouples may be embedded in the receiver or receivers and used as control inputs for controlling the heliostats. In order to control the heliostats to correct a measured configuration or seek a goal configuration, a model based control system may be used which obtains inputs such as the level of insolation on each respective heliostat, the pattern of light that is reflected by each heliostat for a given angle of incidence and aiming, and other parameters, which may be stored in a memory.

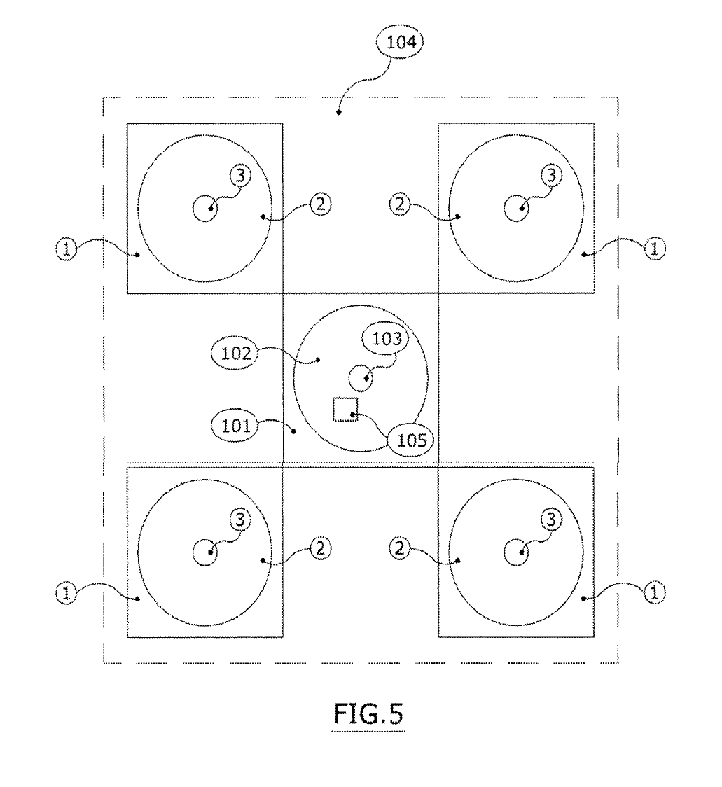

Referring now to FIG. 5, a system 104 comprising n+1 solar fields 1 and n+1 solar power towers 3 and 103 each fixedly positioned therein is shown, where by way of illustration n is equal to four. The system is laid out so that in each of n solar fields 1 a tower 3 is associated with a heliostat field 2 such that each tower 3 stands within the boundaries of the heliostat field 2 with which it is associated, and in an n+1 th solar field 101, an n+1th central solar power tower 103 is associated with a heliostat field 102 such that the n+1th tower 103 stands within the boundaries of the heliostat field with which it is associated. Preferably, for every n+1 towers 3 and 103, one tower 103 is dedicated both to the superheating of steam substantially generated in the other n towers 3 and to the reheating of steam transported thereto from an outlet of a steam turbine with a reheat cycle (not shown) in that the solar receiver (not shown) atop tower 103 is configured specifically for superheating and reheating steam. A steam turbine electric power plant 105 is provided in close proximity to the n+1th tower 103 in order to minimize the extent and distance to which steam is transported.

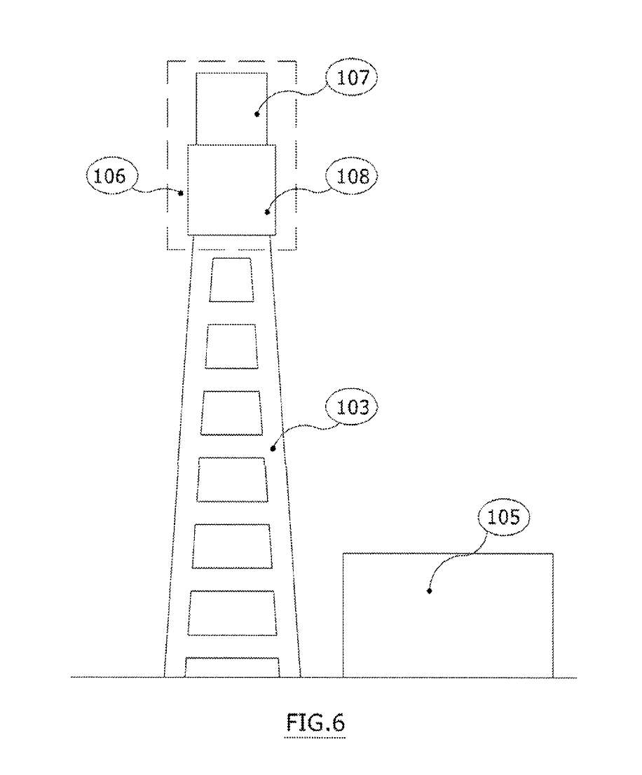

Referring now to FIG. 6, in accordance with another embodiment of the invention, there is provided a solar receiver 106 situated substantially at the top of an n+1th tower 103 both for superheating steam optionally transported thereto from at least one other solar receiver (not shown) or at least one other boiler (not shown) and for reheating steam transported thereto from an outlet of a steam turbine with a reheat cycle (not shown). In one aspect of a preferred embodiment the solar receiver 106 comprises two boilers 107 and 108 where one boiler 107 is provided for superheating steam and other boiler 108 is for reheating steam. Boilers 107 and 108 could alternatively be configured as two separate sections of a single boiler. A steam turbine electric power plant 105 is provided in close proximity to the n+1th tower 103 in order to minimize the distance to which steam is transported, and the reheating boiler 108 is positioned at a lower height than the superheating boiler 107 so as to minimize the extent and distance to which the lower pressure steam of the reheat cycle is transported.

As discussed above, a principal criterion for optimization is that solar radiation reflected onto the external surface of the superheating receiver conforms to some goal flux distribution or temperature distribution profile. This uniform distribution allows for precise control of superheated steam conditions, which may be necessary for efficient use of the steam by a steam turbine electric power plant. Variations in the solar heat flux incident on the surface of the superheating receiver (i.e., a non-uniform heat flux) may affect the state of the superheated steam, which, in turn, could adversely affect power generation efficiency. Further, variations in the solar heat flux may lead to localized temperature variations (i.e. hot spots) on the surface of the receiver. These hot spots may have a temperature exceeding the failure threshold for the receiver material. In addition, the temperature variation between adjacent portions of the receiver may induce thermal stresses due to differing amounts of thermal expansion that could lead to eventual failure. By ensuring a uniform heat flux distribution, the highest possible temperature can be achieved for the superheated steam without localized hot spots that may damage the superheating receiver. In accordance with this goal, an exemplary embodiment of the present invention seeks to maintain a uniform heat flux distribution on the superheating receiver by dynamically controlling the focal points of heliostats.

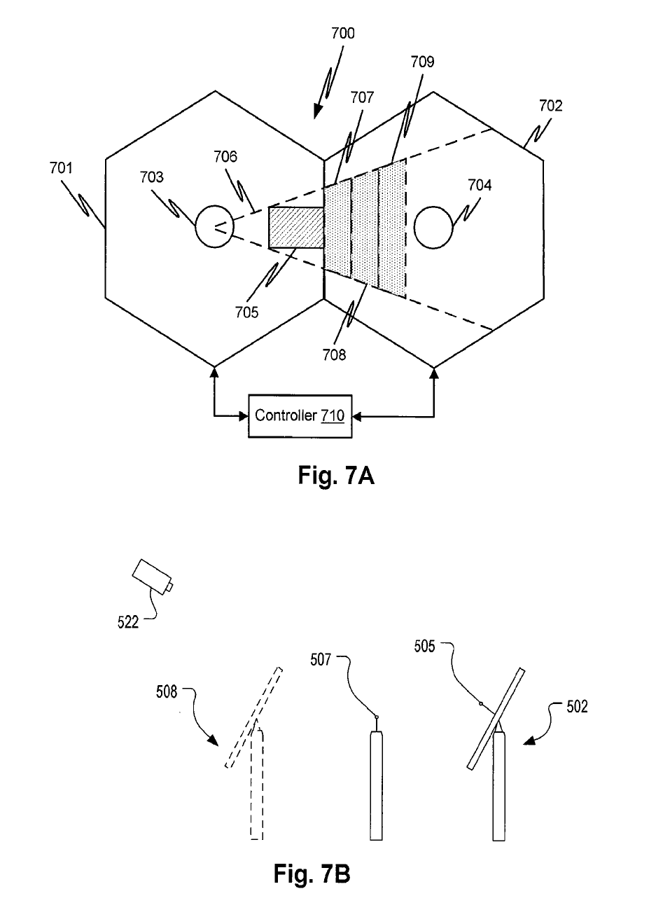

FIG. 7A is a diagrammatic view of a system 700 of distributed solar power towers and associated fields of heliostats in accordance with an embodiment of the invention. System 700 includes towers 703, 704 centered within respective hexagonal fields 701, 702 of heliostats (not shown). Tower 703 is dedicated to the superheating of steam. Tower 704 is dedicated to the generation of steam for use by the superheating tower 703. Although only a single tower 704 is shown, additional steam generation towers are contemplated. It is also noted that the fields 701, 702 of heliostats are shown as regular hexagons for illustration purposes only. Other polygonal and non-regular geometric shapes may be used for the fields of heliostats.

At least initially, the heliostats in field 701 are configured to direct radiation onto superheating tower 703. Similarly, the heliostats in field 702 are configured to direct radiation onto steam generation tower 704. However, the focal direction for each heliostat in each field 701, 702 is dynamically configurable such that the radiation reflected from a particular heliostat may be switched from one tower to another.

Controller 710 is provided to control the focal direction for the heliostats in fields 701 and 702. Although only a single controller is shown, a separate controller may be provided for each field of heliostats. Alternately, each heliostat may have its own controller. Controller 710 may also serve to monitor the heat flux on the superheating receiver in tower 703 and to determine the necessary adjustment of the heliostats fields 701, 702 to maintain the heat flux on the superheating receiver. Alternately, a separate system may be provided which monitors the heat flux distribution on the superheating receiver and conveys such information to the controller 710 for subsequent optimization of the fields of heliostats.

Monitoring the heat flux and/or temperature distribution on the receivers, such those on the superheating tower 703, may be achieved by several different techniques. In one embodiment, the thermocouples or other temperature sensors may be affixed to the receiver. Variations in the temperature may then be correlated to variations in incident heat flux on the superheating receiver. In another embodiment, temperature or heat flux measurements may be taken of the superheating receiver. This may be achieved by thermal imaging (e.g., infrared (IR) thermography) of the superheating receiver or image processing of optical images to determine the profile of reflected optical energy.

Referring to FIG. 7B, in another embodiment, the radiation incident on each heliostat may be monitored using photometric techniques. An image capture system, for example one employing a digital camera 522, captures images of reflectors, for example reflectors 508 mounted some or all of the heliostats 502, 508 or reflectors 507 positioned at various points in the array. The reflectors 507, 508 may be diffuse reflectors having a selective surface coating or color that makes their images easier to separate from the background image. The quantity of light falling on the reflector 507, 508 may be determined by appropriate optical and digital filtering and image processing using suitable techniques.

Additionally or alternatively, each heliostat 502, 508, or group of heliostats, may be provided with an insolation level detector (which may also be positioned as indicated at 507 and 505 in FIG. 7B), such as a pyranometer or pyrheliometer. The detectors may be mounted in the center of the heliostat as indicated at 505 or another location thereon so as to provide a measure of the solar energy incident on the heliostat. Alternately, a plurality of insolation level detectors 507 may be strategically placed throughout the field of heliostats, whereby the insolation level detected by each detector is correlated with a number of the heliostats surrounding it.

In the event of a disruption to the uniform insolation distribution on the receiver resulting from heliostats being “lost” due to mechanical failure, cloud coverage, fouling of the reflective surface, or other causes, heliostats otherwise assigned to one receiver may be “borrowed” to direct energy to another receiver. For example, in a simplified example, suppose that heliostats in field 701 within region 705 reflect less solar radiation than normally expected. This may be determined by measurement of instantaneous energy falling on the heliostats or inferentially by a change in the temperature or flux on the receiver. Such a scenario may arise, for example, due to a passing cloud that may temporarily shield a portion of the heliostats from the sun, the angle of the sun causing shading of heliostats by tower 703, or failure of the heliostats in a particular region of the field. Note that the results can also be predicted by a predictive control algorithm when the loss of heliostats is a predeterminable event. As a result of the reduced output from region 705, the solar heat flux on a portion facing region 705 of the superheating receiver is diminished. In order to maintain the desired heat flux distribution on the superheating receiver, controller 710 determines that reflected radiation from additional heliostats is needed.

To determine the heliostats for redirection, the controller 710 calculates a pair of demarcation lines 706 extending from the center of the superheating receiver. The demarcation lines are drawn such that they border the region 705 of heliostats in field 701 determined to be deficient in delivering solar heat flux to the superheating receiver. Alternately, the demarcation line may be drawn to border the circumferential portion of the superheating receiver which has a non-uniform flux distribution. The demarcation lines 706 extend into the adjacent field of heliostats 702, thus defining a candidate region of heliostats in field 702. This candidate region may be further sub-divided into a plurality of groups. For example, the candidate region may be sub-divided into groups 707, 708, and 709 based on distance from the edge of field 701. Although only three groups have been illustrated in the FIG. 7, additional groups in field 702 may be included. It is, of course, contemplated that other grouping schemes may be employed. For example, groupings may be based on the radial distance from the superheating receiver in tower 703.

Controller 710 then selects the group 707 closest to the edge of field 701. For the heliostats within the group 707, the controller determines the amount of heat flux from each heliostat that would be directed on the superheating receiver if the heliostats were redirected to focus on the non-uniform region of the superheating receiver. Based on this calculation, the controller 710 can select certain heliostats from the group 707 for redirection to the superheating receiver so as to balance non-uniform region. The controller 710 may also command all of the heliostats from group 707 to redirect to the superheating receiver based on the degree of non-uniformity. In the event that the heat flux directed on the superheating receiver in tower 703 by group 707 is not sufficient to overcome the non-uniformity, the controller may then proceed to perform the above methodology on group 708. Likewise, if the combined heat flux from groups 707 and 708 is insufficient, the above methodology may be performed on group 709. This process may continue with additional groups arranged at distances progressively farther from the edge of field 701 and within demarcation lines 706 until the non-uniformity in the heat flux distribution is corrected or until some predetermined condition is reached. It is also noted that the heliostats within a group are only nominally associated and thus do not need to be redirected as a whole. Rather, a portion of the heliostats within a group may be redirected if their heat flux is sufficient to cure the non-uniform distribution on the superheating receiver.

Although only one field 702 of heliostats is shown adjacent to the field 701 with the superheating tower 703, additional fields may be provided. In such a scenario, the demarcation lines 706 may continue into the next field of heliostats for demarcating another group of heliostats for possible redirection onto the superheating tower 703. It is noted that the superheating tower 703 need not be provided with its own field of heliostats 701. Instead, the superheating tower 703 may be arranged at the border between adjacent heliostat fields. In such an arrangement, a portion of each of these adjacent heliostat fields would be redirected onto the superheating tower. It is further noted that the towers do not need to be located in the center of the field of heliostats, as shown. On the contrary, depending on geographic location, the orientation of the tower within the field of heliostats may be off-centered. Alternately, the tower may be situated external to the field of heliostats with which it is associated.

Note that although according to the above discussion, adjacent heliostats are re-aimed to compensate for loss of adjacent heliostats, the lost heliostats and the redirected heliostats need not lie in adjacent groups. The controller may be provided with sufficient information to “cherry-pick” the most suitable heliostats to use for compensation. And failures need not occur over contiguous portions of the heliostat fields.

It is noted that the above description relates to directing heliostats onto the superheating receiver when a non-uniform heat flux is detected. However, variations in insolation or other conditions may cause portions of the receiver in the superheating tower 703 to exceed a predetermined value (i.e., a hot spot). In such a case, the controller 710 may redirect heliostats focused on the superheating receiver to other focal points. As above, demarcation lines 706 may be drawn to define a region of heliostats for potential redirection. These heliostats may be divided into groups based on distance from the superheating tower 703, wherein the controller 710 individually controls the heliostats within each group. The controller may select a group farthest from the superheating tower and determine the amount of heat flux from each heliostat within the selected group. Based on this calculation, the controller 710 can then choose certain heliostats from the selected group for redirection. These heliostats may be redirected to a different tower (e.g., tower 704) or away from any tower (e.g., the sky). The controller 710 may also command all of the heliostats from the selected group to redirect away from the superheating receiver based on the degree of non-uniformity. In the event that the non-uniformity remains after redirection, the controller may then proceed to the next closest group and repeat the above sequence. This process may continue with additional groups within the demarcation lines and progressively closer to the superheating tower until the non-uniformity in the heat flux distribution is corrected or until some predetermined condition is reached.

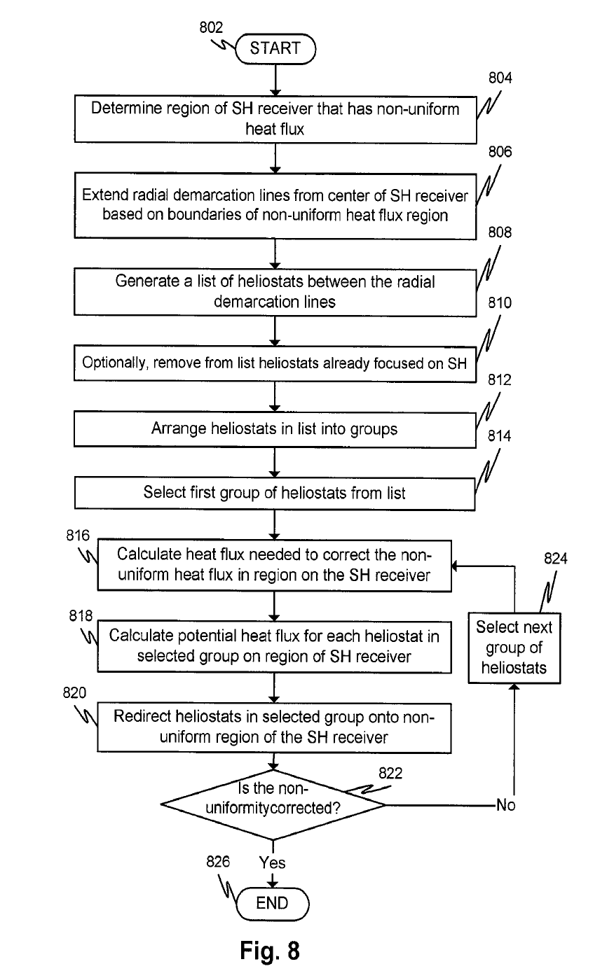

FIG. 8 is a simplified process flow diagram of an exemplary embodiment of a process used, for example, by controller 710 in FIG. 7. The process may begin with step 802 and proceed to step 804. At step 804, the uniformity of the heat flux incident on the receiver in a superheating tower is determined. In particular, regions of the superheating (SH) receiver that are non-uniform, either due to a deficient or excessive amount of heat flux, are noted. The process then proceeds to step 806. At step 806, a pair of demarcation lines are extended from the center of the SH receiver. The demarcation lines are drawn such that they border the region of heliostats in field determined to be deficient in delivering solar heat flux to the SH receiver. Alternately, the demarcation line may be drawn to border the circumferential portion of the superheating receiver which has a non-uniform flux distribution. The demarcation lines extend into the adjacent fields of heliostats, thus defining a candidate region of heliostats.

The process then proceeds to step 808. In step 808, a list of heliostats within the candidate region and between the demarcation lines is generated. Proceeding to step 810, the heliostats currently directed on the SH receiver may be removed from the list. However, it is not required that the heliostats currently directed on the SH receiver be removed from the list. Instead, the controller 710 may take into account heliostats already focused on the SH receiver in any subsequent process steps.

At step 812, the heliostats within the list are sub-divided into a plurality of groups. For example, the candidate region may be sub-divided into based on distance from the edge of field surrounding the SH receiver. In another example, groupings may be based on the radial distance from the SH receiver. Proceeding to step 814, a first group is selected from the plurality of groups. The selection may be based on proximity to the edge of the field surrounding the SH receiver. Other criteria may also be used for selection of the first group. For example, the controller may select the group based on a predetermined pattern or historic data.

Proceeding to step 816, the amount of heat flux and location on the SH receiver necessary to correct the non-uniformity in the SH receiver is calculated. The procedure then advances to step 818. At step 818, the potential amount of heat flux from each heliostat in the selected group is calculated. In particular, it is determined how much heat flux each heliostat in the group would provide if the heliostat were redirected onto the non-uniform region of the SH receiver. Based on the results of step 818, at least a portion of the heliostats within the selected group are redirected to the non-uniform region of the SH receiver in step 820. Only a portion of the heliostats from the selected group may be selected for redirection if the non-uniformity is minor. However, depending on the degree of non-uniformity, all heliostats within the selected group or additional heliostats from other groups may be necessary. In step 822, the process checks if the non-uniformity in the heat flux on the SH receiver has been corrected by the redirected heliostats. If not, the process proceeds to step 824. In step 824, the next group is selected from the list of heliostats. Steps 816 through 822 are then repeated. If the non-uniformity is corrected by the redirected heliostats, the process then terminates at step 826. The above process may be repeated as necessary in real-time or at particular time intervals, depending on computing resources and system requirement. For example, the process may be repeated every 5 minutes.

It is noted that steps 816 and 818 may precede steps 812 or 814, in which case the potential heat flux for each heliostat may be used in the generation of the list or the selection of the groups. In such a scenario, the potential heat flux may be used in determining which group of heliostats to select first. For example, the group of heliostats having the highest potential heat flux may be selected as the first group. It is also noted that step 824 also does not need to return to step 816, but may instead proceed directly to step 820.

It is noted that the process flow described above with respect to FIG. 8 is only exemplary in nature. More complicated and extensive processes for controlling and optimizing the focal direction for the various heliostats are also contemplated. For example, a controller 710 may employ a model-based control for redirecting the heliostats from a steam generation tower to the superheating tower. Inputs on system variables may be input to the controller, which would then employ model-based techniques to determine the optimal configuration for the heliostats. Inputs may include insolation rate as determined by detectors on the heliostats or in the heliostat field, reflected heat flux as measured by photometric techniques, or temperature variations of the receiver as measured by thermal imaging or arrays of temperature sensors. For example, a genetic algorithm may be used to optimize the configuration of the heliostats based on at least a portion of these inputs.

The controller may also employ control schemes which seek to minimize a calculation of heat flux uniformity for the SH receiver. For example, the controller may employ the equation:

$${{\sum }_{i}}^{N} \vert {q}_{i} - \overline{q} \vert * {c}_{T} ,$$

wherein i represents a particular face or panel of the SH receiver, N represents the total number of faces or panels of the SH receiver, qᵢ represents the heat flux incident on the ith face or panel, q̅ represents the average heat flux on the SH receiver, and c_{T} is a calibration factor. The controller may thus be configured to redirect heliostats from various different fields onto the SH receiver so as to minimize the above equation. Note that the calibration factor c_{T} may be temperature dependent. This factor may thus account for increased criticality of heat flux uniformity at higher temperatures.

The embodiments discussed above may also be applied to non-uniform heat flux on the SH receiver in two dimensions. Referring to FIG. 7, the controller 710 could be configured to not only optimized the uniformity in the plane of the heliostat field 701, but also in a direction perpendicular to the heliostat field 701 and parallel to the tower 703. The controller may need to account for beam shape and any associated spillage (i.e., energy extending beyond the beam waist of the Gaussian profile) of the reflected beam from each heliostat in determining the placement of the focal point on the surface of the SH receiver so as to account for the non-uniformity in both directions.

In addition, the system may be configured to account for real-time or near-real-time variations by optimizing the configuration of the heliostats in all fields. For example, for each heliostat, the controller may determine a beam quality. The beam quality would be based on the size of the beam shape from the heliostat and the amount of heat flux reflected by the heliostat, with smaller beam sizes and higher heat fluxes resulting in higher beam quality. Because of its position dependence, the beam quality would be determined for each panel of the SH receiver. The controller may then organize the heliostats into a list extending from highest beam quality to lowest beam quality. Based on the desired heat flux desired for each panel and the insolation levels, the controller may then assign heliostats having the highest beam quality to the SH receiver, while leaving lower beam quality heliostats available for the steam generating towers. Alternately, different lists of heliostats may be provided for each tower, not just the SH. In such an arrangement, the lists would be used by the controller in determining assignment of the heliostats, with the SH receiver having priority over the other towers.

The embodiments discussed above are particularly applicable when a non-uniform heat flux profile is generated on the receiver of a superheating tower. However, such embodiments are also applicable to insolation variations during sunrise and sunset, where a rapidly changing radiation angle coupled with rapidly changing radiation intensity. Such scenarios may benefit from optimization of the direction of the heliostats on the superheating receiver for improved efficiency.

Given that the solar flux is unstable and varies through the day and during different seasons of the year, the turbine electric power plant should be able to operate at partial loads when solar radiation intensity diminishes. For situations when the total insolation available drops, the energy generation system may compensate by adopting a sliding pressure methodology for the turbine electric power plant, whereby superheated steam can be generated by the superheating receiver, but at a lower pressure to compensate for the reduced heat flux. Alternately, a sliding flow methodology may be used. In the latter method, the flow rate through the steam generation towers, superheating tower, and the turbine are adjusted to account for the reduced heat flux provided by the reduced insolation. The controller may adjust the focal direction for the different heliostats depending on the methodology employed to maintain optimal pressure and temperature for the superheated steam input to the turbine electric power plant.

Although steam has been discussed in particular throughout this specification, it should be evident from the specification that other working fluids could be used other than water/steam and/or other power cycles than Rankine such as Brayton, Stirling, etc could also be used.

Although in most of the embodiments, the preheating, evaporating, superheating, and reheating stages are described as being done in separate receivers (or the heating for the same if a heat transfer fluid is used for one or more stages), the stages can be combined in a tower or even in a receiver while still providing the advantages associated with selectively controlling heliostats to aim at different points on a single receiver or tower-to-tower switching among towers. For example, it may be that in a multi-tower system evaporation and superheating are done in receivers or receiver portions in each tower. In such a system, it may be desirable for heliostat aiming to be done in such as way as to achieve a temperature or flux uniformity goal from tower to tower or among portions of receivers in such systems.

The following is a description of an exemplary embodiment, in addition to the embodiments described above.

Multiple power towers with surrounding arrays of heliostats using flat glass for reflection. The heliostats reflect sunlight onto a solar receiver positioned at the top of each tower. A 100 MW-electrical (MWe) plant is described which may be scaled. The plant has three solar power towers generating power supporting one 100 MWe conventional reheat cycle steam turbine. Two identical towers with saturated gas (SG) receivers (or evaporation or saturated boilers) or SG Towers, generate saturated steam at 183.5 bar @358.5° C. The third tower (SH/RH Tower) located next to the power block is dedicated for superheating and reheating of the steam. Locating the SH/RH tower close to the power block minimizes heat loss from piping from the SH/RH tower which is at the highest temperature.

Steam conditions entering the high pressure (HP) section in the turbine is 160 bar 540° C. Steam conditions entering the low pressure (LP) section, used with reheated steam, of the turbine is 32 bar 480° C. Each tower collects energy from approximately 27,000 heliostats arranged asymmetrically in 360° arc-rows around the tower. The configuration is exemplary for a location on flat land at about 35 degrees latitude north of the equator. The two SG towers are each equipped with a surrounding array of heliostats whereas the SH/RH tower, located at the center, shares heliostat with the other two.

From a control standpoint, first priority is given to the SH/RH tower (the third tower). Its energy (flux) needs are controlled very accurately along the day and seasonally. The other two towers, used for steam generating and possibly the first stage of superheating can accept wider flux fluctuations, and therefore accept the remaining energy available after the SH tower flux is satisfied.

The two SG boilers are identical and comprised of vertical steam generating panels, arranged in a circle at the top of each SG power tower. The diameter is 8 m. The exposed panel height is approximately 11 m.

The central SH/RH receiver is about 7.25 m wide and 12 m height and exposed to solar flux on all sides.

Design parameters in non-specified respects are kept, as much as possible, within the normal practice for standard commercial boiler systems, including:
Boiler type—Forced recirculation drum type.
Panel radiation heat flux at levels normally experienced in the boiler industry, such as:
   Up to 600 kW/m² in its steam generation section.
   130-230 kW/m² in its superheating sections (levels vary between SH passes).

The power block collects energy from the three central solar towers and generates power using a conventional re-heat turbine cycle. The power block has a net electrical output of 100 MWe and requires thermal input (net absorbed) of 253.1 MW thermal (MWth). It is fed by superheated steam at 160 bar, 540 deg C. (steam turbine live steam conditions). The nominal (full load) absorbed power (net) is 70.3 MWth for each one of two steam generation power towers (SG Boilers) and 112.5 MWth for the third central tower (SH/RH). The system should also be able to operate at partial loads when solar radiation intensity diminishes. The boiler and the whole system operation at partial load may control parameters such as water/steam flow velocity, heat transfer rate and the cycle thermal efficiency to optimize performance.

Certain features of this invention may sometimes be used to advantage without a corresponding use of the other features. While specific embodiments of the invention have been shown and described in detail to illustrate the application of the principles of the invention, it will be understood that the invention may be embodied otherwise without departing from such principles.

Embodiments of the system and method according to this invention may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any process capable of implementing the functions or steps described herein can be used to implement embodiments of the invention.

Furthermore, embodiments of the system and method according to this invention may be readily implemented, fully or partially, in software using, for example, object or object-oriented software development environments that provide portable source code that can be used on a variety of computer platforms. Alternatively, embodiments of the disclosed system and method according to this invention can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the system and method according to this invention can be implemented in hardware and/or software using any known or later developed systems or structures, devices and/or software by those of ordinary skill in the applicable arts from the function description provided herein and with a general basic knowledge of the computer arts, solar boiler technology, and control systems.

Moreover, embodiments of the system and method according to this invention can be implemented in software executed on a programmed general purpose computer, a special purpose computer, a microprocessor, or the like. Also, embodiments of the system and method according to this invention can be implemented as a program embedded on a personal computer such as a JAVA® or CGI script, as a resource residing on a server or image processing workstation, as a routine embedded in a dedicated processing system, or the like. The method and system can also be implemented by physically incorporating the control method into a software and/or hardware system, such as the hardware and software systems of each heliostat.

It is, therefore, apparent that there is provided, in accordance with the present invention, a system and method for a distributed solar power tower system with dynamically configurable heliostats controlled to optimize a predetermined state of the critical receiver in one tower. While this invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of this invention.

What is claimed is:

1. A solar energy collection system comprising:
one or more first towers and one or more second towers, each first tower supporting a first receiver and each second tower supporting a second receiver, each second receiver configured to generate steam using energy from radiation incident thereon, each first receiver receiving the generated steam from one or more second receivers and superheating the steam using energy from radiation incident thereon;
a plurality of heliostat-mounted mirrors, each second tower being assigned a respective subset of the plurality of heliostat-mounted mirrors, each heliostat-mounted mirror in the respective subset directing incident solar radiation onto the second receiver in the assigned second tower; and
a controller configured to control the plurality of heliostat-mounted mirrors,
wherein the controller is capable of changing the assignment of heliostat-mounted mirrors in each said subset so as to redirect incident solar radiation onto the first receiver of the one or more first towers so as to maintain a predetermined state of the first receiver.

2. The solar energy collection system of claim 1, wherein the predetermined state includes a ratio of incident solar radiation directed onto the first receiver in the one or more first towers to incident solar radiation directed onto the second receiver in the one or more second towers.

3. The solar energy collection system of claim 1, wherein the predetermined state includes a uniform temperature on surfaces of each first receiver.

4. The solar energy collection system of claim 1, wherein the predetermined state includes a uniform heat flux on surfaces of each first receiver.

5. The solar energy collection system of claim 1, wherein the predetermined state includes a temperature profile on surfaces of each first receiver.

6. The solar energy collection system of claim 1, wherein the predetermined state includes a heat flux profile on surfaces of each first receiver.

7. The solar energy collection system of claim 1, wherein each first receiver operates at a higher temperature than each second receiver.

8. The solar energy collection system of claim 1, further comprising a turbine electric power plant configured to use the superheated steam from the first receiver of the one or more first towers.

9. The solar energy collection system of claim 8, wherein the one or more first towers are arranged closer to the turbine electric power plant than the one or more second towers.

10. The solar energy collection system of claim 1, wherein each first tower is assigned a different respective subset of the plurality of heliostat-mounted mirrors, each heliostat in the different respective subset directing incident solar radiation onto the first receiver in the assigned first tower.

11. The solar energy collection system of claim 10, wherein the controller is capable of changing the configuration of each said different subset to direct incident solar radiation onto or away from the respective first receiver.

12. The solar energy collection system of claim 1, comprising a monitoring system configured to monitor the state of the first receiver in the one or more first towers, wherein the controller uses the information from said monitoring system to determine changes in the configuration of each said subset.

13. A solar power system, comprising:
at least one central receiver with at least two receiver portions defining at least two respective targets;
heliostats arranged in a two-dimensional pattern and configurable such that each can track the apparent diurnal and trans-seasonal movement of the sun to direct sunlight onto an assigned one of the targets;
the targets being located at different locations;
at least some of the heliostats being configured to move in two dimensions to direct sun onto a first assigned one of the targets and on a second assigned one of the targets;
a controller configured to select a heliostat and change its assigned target responsively to real time insolation data.

14. The system of claim 13, further comprising insolation level sensors arranged to detect respective levels of light captured by respective ones of the heliostats, the insolation level sensors outputting the real time insolation data.

15. The system of claim 13, wherein the at least one central receiver includes at least two receivers, a first of the at least two receivers having a first operating temperature and a second of the at least two receivers having a second operating temperature, the first temperature being higher than the second.

16. The system of claim 13, wherein the at least one central receiver includes at least two receivers, a first of the at least two receivers having a first operating temperature and a second of the at least two receivers having a second operating temperature, the first temperature being higher than the second; the first and second receivers having respective surfaces to which solar energy is incident; the controller being configured to assign heliostats to achieve uniform temperature over the first receiver surface at the expense of uniformity of temperature over the second receiver surface.

17. A method of controlling a central solar concentrating energy system, comprising:
at a first time, determining the amount of energy directable by each of a plurality of heliostats onto each of at least two targets located at different positions;
the targets including heat exchangers configured to heat a working fluid and power a generator;
at a first time aiming each of the plurality of heliostats on a first respective one of the at least two targets responsively to a result of the determining;
repeating the determining at a second time;
at the second time, aiming at least one of the plurality of heliostats aimed in the first aiming on a second, different respective one of the at least two targets.

18. The method of claim 17, wherein the determining includes measuring respective rates of insolation on each of the plurality of heliostats or groups thereof.

19. The method of claim 17, wherein the at least two targets are located on separate towers.

20. The method of claim 17, wherein the first respective one of the at least two targets has a higher operating temperature than the second respective one of the at least two targets.

21. The method of claim 17, wherein the first respective one of the at least two targets has a higher operating temperature than the second respective one of the at least two targets and further comprising determining a uniformity of temperature or energy flux on the first receiver, wherein the second aiming is responsive to the determining a uniformity.

22. The method of claim 17, wherein the first respective one of the at least two targets has a higher operating temperature than the second respective one of the at least two targets and further comprising measuring a uniformity of temperature or energy flux on the first receiver, wherein the second aiming is responsive to the measuring a uniformity.

23. A method for controlling heliostat-mounted mirrors in a solar energy collection system, the solar energy collection system including a first receiver, a second receiver, and a plurality of heliostat-mounted reflectors, the first receiver having more stringent operating criteria than the second receiver, each heliostat-mounted reflector assigned to one of the first receiver or the second receiver such that the heliostat-mounted reflector directs incident solar radiation onto the assigned first or second receiver, the method comprising the steps of:
observing a state of the first receiver;
comparing the observed state to a predetermined state for the first receiver, the predetermined state being related to the operating criteria for the first receiver; and
changing the assignment of at least a portion of the plurality of heliostat-mounted mirrors based on the comparing.

24. The method of claim 23, wherein the predetermined state includes a predetermined temperature profile of a surface of the first receiver.

25. The method of claim 23, wherein the predetermined state includes a predetermined heat flux profile on a surface of the first receiver.

26. The method of claim 23, wherein the first receiver operates at a higher temperature than the second receiver.
